(19) United States
(12) Patent Application Publication
(10) Pub. No.: US 2006/0041368 A1
(43) Pub. Date: Feb. 23, 2006

(54) Systems, Methods and Computer Program Products for Remote Monitoring of Turbine Combustion Dynamics

(75) Inventors: George Edward Williams, Niskayuna, NY (US); Scott Campbell Mattison, Salem, VA (US); Eamon P. Gleeson, Atlanta, GA (US)

Correspondence Address: SUTHERLAND ASBILL & BRENNAN LLP, 999 PEACHTREE STREET, N.E., ATLANTA, GA, 30309, US

(73) Assignee: GENERAL ELECTRIC COMPANY, Schenectady, NY (US)

(21) Appl. No.: 10/711,028

(22) Filed: Aug. 18, 2004

(51) Int. Cl. G01M 17/00

(52) U.S. Cl. 701/100; 701/29

(57) ABSTRACT

Systems, methods and computer program products enable the remote monitoring of the combustion dynamics of turbines. Remote monitoring permits a single user to continuously monitor the operating health of a fleet of turbines simultaneously from a single location. The user is presented with one or more graphical user interfaces that graphically display combustion dynamics data to enable the user to visually and quickly determine whether the turbine is operating within prescribed limits. The system permits the user to determine whether each turbine is operating to its maximum efficiency.

### BACKGROUND OF INVENTION

The present invention relates to turbines, and more particularly, to systems, methods and computer program products for remotely monitoring the combustion dynamics of turbines to enhance their operation.

As part of the monitoring controls and diagnostic tools for an operating combustion system in a rotary machine such as a gas turbine, it is necessary to measure and acquire various data including combustion chamber dynamic pressure. This data is used to confirm proper operational health of the combustion system, and is also used to tune the turbine engine so that it is operating with an appropriate balance between combustion dynamics and emissions.

Measuring the dynamic pressure in the combustion chamber to monitor turbines is well known. U.S. Pat. Nos. 6,722,135, 6,708,568, and 6,694,832, each owned by the assignee of the present invention, generally describe the use of pressure chamber devices and measurements to monitor vibration in the firing chamber of gas turbines. Such vibration monitoring allows turbines to be run closer to their fail points because the system can detect and take appropriate action should vibration in the turbines exceed pre-established limits. For instance, in response to detrimental pressure within combustion chambers, a turbine may be slowed to allow it to stabilize. After stabilization the turbine may be once run at higher output levels, such that the overall operational efficiency levels of the turbine are enhanced.

Current combustion chamber dynamic pressure monitoring systems are local to the turbine that is monitored. For instance, at least one system, the EDAS-CE™ by Experimental Design and Analysis Solutions, is a combustion monitoring system positioned local to a turbine to be monitored. Using local monitoring systems requires that engineers perform maintenance and/or tune turbines at their location. This typically occurs routinely, such as twice a year. This process is expensive because it requires site visits to each turbine. These systems also fail to provide continuous monitoring to prevent turbine failure.

What is therefore needed is a system and method for remotely monitoring the combustion dynamics of turbines to enhance their operation.

### SUMMARY OF INVENTION

The present invention is directed generally to systems, methods and computer program products that enable the remote monitoring of the combustion dynamics of turbines. Remote monitoring permits a single user to continuously monitor the operating health of a fleet of turbines simultaneously from a single location. According to one aspect of the present invention, the user is presented with one or more graphical user interfaces that graphically display combustion dynamics data to a user to enable the user to visually quickly determine whether the turbine is operating within prescribed limits. The system permits the user to determine whether each turbine is operating to its maximum efficiency. According to one aspect of the present invention, based on the combustion dynamics data, the operation of each turbine within a fleet of turbines may be controlled, either by the operator or automatically.

According to one embodiment of the present invention, there is disclosed a method there is disclosed a system for monitoring a plurality of turbines. The system includes at least one turbine and at least one combustion dynamics monitoring device in communication with the at least one turbine. The at least one combustion dynamics monitoring device is operable to measure the pressure within at least one combustion chamber of the at least one turbine. The system also includes at least one fleet server in remote communication with the at least one combustion dynamics monitoring device, operable to generate a graphical display illustrating the operational status of the at least one turbine.

According to one aspect of the invention, the system further includes at least one turbine monitoring device in communication with the at least one turbine, operable to monitor non-pressure related information associated with the at least one turbine. According to another aspect of the invention, the at least one fleet server is in communication with the at least one turbine monitoring device, and the at least one fleet server receives the non-pressure related information from the at least one turbine monitoring device. According to yet another aspect of the invention, the graphical display generated by the at least one fleet server illustrates the pressure within the at least one combustion chamber of the at least one turbine. The graphical display generated by the at least one fleet server may also simultaneously illustrate the pressure within the at least one combustion chamber of a plurality of the at least one turbine.

According to another aspect of the invention, the at least one combustion dynamics monitoring device may be further operable to generate frequency information revealing acoustic vibrations in the at least one turbine. The frequency information can include the maximum pressure within each of the at least one combustion chamber of the at least one turbine. Furthermore, the frequency information may reveal acoustic vibrations in the at least one turbine in a plurality of frequency bands, which may exist within the frequency ranges of 0 to about 3200 Hertz.

According to yet another aspect of the invention, the graphical display generated by the fleet server identifies the combustion chamber having a maximum pressure value measured by the at least one combustion dynamics monitoring device. The graphical display generated by the fleet server may also include the site location of the at least one turbine. Additionally, the at least one fleet server may be accessible by users via the Internet.

According to another embodiment of the present invention, there is disclosed a method for monitoring a plurality of turbines. The methods includes using at least one combustion monitoring device to monitor the pressure within at least one combustion chamber of at least one turbine, and communicating the monitored pressure to at least one fleet server in communication with the at least one combustion monitoring device. The method also includes displaying, using the fleet server, the operational status of the at least one turbine.

According to one aspect of the invention, the method further includes the step of using at least one turbine monitoring device to monitor non-pressure related information associated with the at least one turbine. According to another aspect of the invention, the method includes the step of receiving, at the at least one fleet server, the non-pressure related information. According to yet another aspect of the invention, the step of displaying may include displaying the pressure within the at least one combustion chamber of the at least one turbine and/or simultaneously displaying the pressure within the at least one combustion chamber of a plurality of turbines.

The method may also include the step, performed by the combustion dynamics monitoring device, of generating frequency information revealing acoustic vibrations in the at least one turbine. The step of generating frequency information may include identifying the maximum pressure within each of the at least one combustion chamber of the at least one turbine. The step of generating frequency information may also include identifying acoustic vibrations in the at least one turbine in a plurality of frequency bands. According to another aspect of the invention, the plurality of frequency bands exist within the frequency ranges of 0 to about 3200 Hertz.

The step of displaying may also include displaying the at least one combustion chamber having a maximum pressure value measured by the at least one combustion dynamics monitoring device. Furthermore, the step of displaying may include displaying the site location of the at least one turbine.

### BRIEF DESCRIPTION OF DRAWINGS

Having thus described the invention in general terms, reference will now be made to the accompanying drawings, which are not necessarily drawn to scale, and wherein:

FIG. 1 shows a block diagram illustrating components comprising combustion dynamics monitoring system, according to one embodiment of the present invention.

FIG. 2 shows a block diagram illustrating components comprising a fleet server, according to one embodiment of the present invention.

FIG. 3 shows a graphical user interface implemented by the fleet data dynamics tool to enable a user to view the combustion dynamics of a fleet of turbines, according to one embodiment of the invention.

FIG. 4 shows another graphical user interface implemented by the fleet data dynamics tool to enable a user to view the combustion dynamics of a fleet of turbines, according to one embodiment of the invention.

FIG. 5 shows a block diagram flowchart illustrating the timing of transmission of data in the combustion dynamics monitoring system of FIG. 1, according to one embodiment of the present invention.

FIG. 6 shows a control panel implemented by the fleet data dynamics tool to enable a user to control the fleet data dynamics tool, according to one embodiment of the invention.

FIG. 7 shows a detail view of turbine and other data, and computation results based thereon, from a fleet turbines, according to one embodiment of the invention.

FIG. 8 shows a graphical user interface implemented by the fleet data dynamics tool to enable a user to view graphical representations of the combustion dynamics of a fleet of turbines, according to one embodiment of the invention.

FIG. 9 illustrates how the graphical representation of the combustion dynamics of a turbine is generated in the graphical user interface of FIG. 8, according to one embodiment of the invention.

FIG. 10 illustrates a graphical user interface implemented by the fleet data dynamics tool to enable a user to view specific combustion dynamic details of a particular turbine, according to one embodiment of the invention.

### DETAILED DESCRIPTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

The present invention is described below with reference to block diagrams and flowchart illustrations of methods, apparatuses (i.e., systems) and computer program products according to an embodiment of the invention. It will be understood that each block of the block diagrams and flowchart illustrations, and combinations of blocks in the block diagrams and flowchart illustrations, respectively, can be implemented by computer program instructions. These computer program instructions may be loaded onto one or more general purpose computers, special purpose computers, or other programmable data processing apparatus to produce machines, such that the instructions which execute on the computers or other programmable data processing apparatus create means for implementing the functions specified in the flowchart block or blocks. Such computer program instructions may also be stored in a computer-readable memory that can direct a computer or other programmable data processing apparatus to function in a particular manner, such that the instructions stored in the computer-readable memory produce an article of manufacture including instruction means that implement the function specified in the flowchart block or blocks.

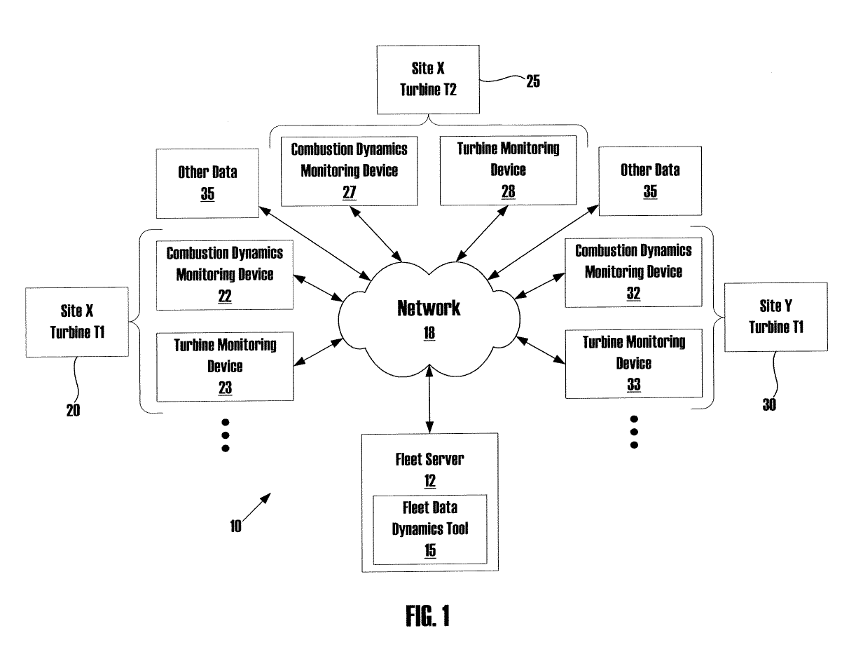

FIG. 1 shows a block diagram illustrating components comprising a combustion dynamics monitoring system 10, according to one embodiment of the present invention.

As illustrated in FIG. 1, the system 10 includes a fleet server 12 in communication with combustion dynamics monitoring devices 22, 27, 32 via a network 18, which may be a wide-area network (WAN), such as the Internet, a local area network (LAN), or another high-speed network as known to those of skill in the art. The combustion dynamics monitoring devices 22, 27, 32 illustrated in FIG. 1 are operable to measure the pressure within the combustion chambers of respective turbines 20, 25, 30 with which they are associated. According to a preferred embodiment of the present invention, the combustion dynamics monitoring devices 22, 27, 32 are in communication with the fleet server 12 using TCP/IP and Ethernet connections via one or more high speed links, such as T-1 lines. Alternative methods of communicating over the network 18 may also be used, such as with conventional modems using plain old telephone service (POTS).

As is also shown in FIG. 1, the fleet server 12 is optionally in communication with turbine monitoring devices 23, 28, 33 via the network 18. As with the combustion dynamics monitoring devices 22, 27, 32, each turbine monitoring device 23, 27, 33 corresponds to a particular turbine 20, 25, 30. Generally, the turbine monitoring devices 23, 28, 33 are operable to report information to the fleet server 12 concerning the operation of their respective turbines 20, 25, 30. Although the present invention will be described herein with respect to a combustion dynamics monitoring system 10 that includes turbine monitoring devices 23, 28, 33 in communication with a fleet server 12, it should be appreciated that the turbine monitoring devices 23, 28, 33 are optional and not required for proper operation of the system 10.

Referring again to FIG. 1, the fleet server 12 includes a fleet data dynamics tool 15 that receives information specific to individual turbines 20, 25, 30 located at remote and/or local sites. The fleet data dynamics tool 15 generates one or more graphical user interfaces, described in detail below, to display data illustrative of the operational status of one or more turbines. Because the fleet data dynamics tool 15 collects and displays information from turbines 20, 25, 30 at multiple remote locations, the fleet data dynamics tool 15 permits a single user to monitor the turbines, as opposed to requiring numerous, dispersed users who locally monitor each turbine. The fleet data dynamics tool 15 permits a single user feedback on the operation of the turbine combustion systems, thereby permitting the user to identify whether a turbine should be tuned so that it is operating with an appropriate balance between combustion dynamics and emissions. According to one aspect of the invention, the fleet data dynamics tool 15 also permits closed loop control of turbines with or without requiring user intervention.

As noted above, each combustion dynamics monitoring device 22, 27, 32 and each turbine monitoring device 23, 27, 33 corresponds to a particular turbine 20, 25, 30. U.S. Pat. Nos. 6,722,135, 6,708,568, and 6,694,832, the content of each of which are incorporated herein by reference, generally describe the use of combustion chamber monitoring devices, such as the combustion dynamics monitoring devices 22, 27, 32 illustrated in FIG. 1, to monitor vibration in the firing chamber of gas turbines. More specifically, the combustion dynamics monitoring devices 22, 27, 32 are operable to measure the pressure within each turbine combustion chamber and can execute a Fast Fourier Transform on pressure readings that converts the pressure readings into a set of frequency spectrums, which show whether acoustic vibrations occur at different frequencies. Viewing the frequencies at which vibrations occur permits a technician or engineer to tune a turbine. Because combustion dynamics (or chamber) monitoring devices are described in detail in the above-incorporated patents, the devices will not be described in further detail herein.

Each combustion dynamics monitoring device 22, 27, 32 creates frequency spectrums representing acoustic vibrations in an associated turbine 20, 25, 30. The combustion dynamics monitoring devices 22, 27, 32 report this information to the fleet server 12 in the form of dynamics data. This dynamics data includes, for multiple frequency bands, the maximum, minimum, and median pressure values for each combustion chamber, as well as the as well as frequency at which each occurs. The combustion dynamics monitoring devices 22, 27, 32 also forward mean and standard deviation values for pressure over all combustion chambers for the same multiple frequency bands. Additionally, error information is provided for the operating condition of the combustion dynamics monitoring devices 22, 27, 32. According to one aspect of the present invention, the dynamics data is generated local to each turbine 20, 25, 30 and forwarded to the fleet server 12 upon request by the server 12. According to a preferred embodiment of the present invention, this occurs periodically, such as every 10 minutes. According to an alternative embodiment of the present invention, the dynamics data may be transmitted from the combustion dynamics monitoring devices 22, 27, 32 to the fleet server 12 routinely or in real-time or near real-time regardless of whether the fleet server 12 requests the dynamics data. The dynamics data is stored by the fleet server 12, as described in detail below, and is used to produce the graphical user interfaces that enable monitoring and/or control of the turbines 20, 25, 30.

According to one embodiment of the present invention, each turbine monitoring device 23, 28, 33 is operable to communicate non-pressure related turbine data for each turbine. Specifically, the turbine monitoring devices 23, 28, 33 may report turbine data, which may include non-combustion related data associated with each turbine, such as the temperature distribution of exhaust gases exiting a turbine, fuel flow information, barometric pressure, exhaust pressure, compressor discharge pressure, compressor pressure ratio, fuel stroke reference, compressor inlet air mass flow, maximum vibration, DLN mode enumerated state, turbine shaft speed, watts generated, compressor inlet temperature, fuel gas temperature, combustion reference temperature, exhaust temperature median corrected by average, and other well known operating parameters useful in analyzing the operation of a turbine. This turbine data, like the dynamics data, may also be transmitted periodically or in real-time or near-real time to the fleet server 12 for use in monitoring the condition of turbines 20, 25, 30.

As is also shown in FIG. 1, other data 35 related to turbines may also be used by the fleet data dynamics tool 15, such as generator information, emission information, or the like. For instance, the other data 35 may include information received from a generator monitor, such as harmonic noise parameters like the amplitude of a microphone at 120 Hertz, the Harmonic Noise Index (HNI), an odd component of the HNI, an even component of the HNI, the vibration component at 60 hertz, the vibration component at 120 hertz, and/or the vibration component at 600 hertz. The other data 35 may also include information received from an emissions monitor, such as carbon monoxide, O2, Nox, and/or corrected values for each.

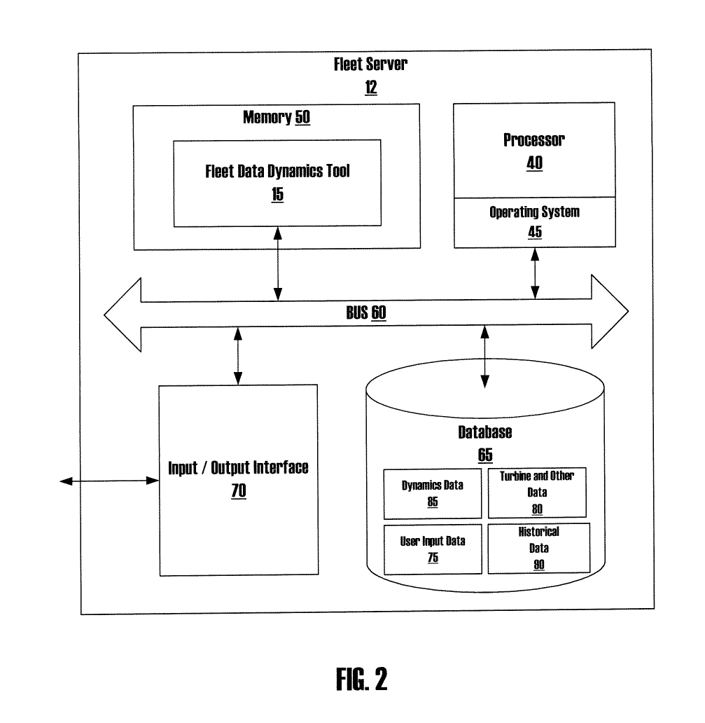

The combustion dynamics monitoring devices 22, 27, 32 described with respect to FIG. 1 and throughout the present disclosure are positioned local to but external from turbines 20, 25, 30 that the monitor. However, it will be appreciated by those of ordinary skill in the art that the combustion dynamics monitoring devices 22, 27, 32 may also be located internal to the turbines 20, 25, 30. According to one aspect of the present invention, a combustion dynamics monitoring device may be incorporated into the turbine control system of each turbine to allow the turbine control system to make control decisions about turbine operations using the combustion dynamics information. For instance, using its own logic the turbine control system may set control parameters to achieve specific operating conditions requested by the operator. Sensors can measure the resulting operating conditions and feed them back to the control system, which may use the measurements to further adjust settings to improve operating conditions until the requested operating conditions are achieved. The control system safeguards the turbine by monitoring whether it is operating within safe conditions. And if safe conditions are exceeded, the control system may alter the operating conditions and may, if necessary, shut down the turbine down. These control decisions may be based in part or entirely on combustion dynamics information provided by a combustion dynamics monitoring device. FIG. 2 shows a block diagram illustrating components comprising the fleet server 12, according to one embodiment of the present invention. As illustrated in FIG. 2, the fleet server 12 generally includes a processor 40, operating system 45, memory 50, input/output interface 70, database 65 and bus 60. The bus 60 includes data and address bus lines to facilitate communication between the processor 40, operating system 45 and the other components within the server 12, including the fleet data dynamics tool 15, the input/output interface 70 and the database 65. The processor 40 executes the operating system 45, and together the processor 40 and operating system 45 are operable to execute functions implemented by the fleet server 12, including software applications stored in the memory 50, as is well known in the art. Specifically, to implement the methods described herein the processor 40 and operating system 45 are operable to execute the fleet data dynamics tool 15 stored within the memory 50.

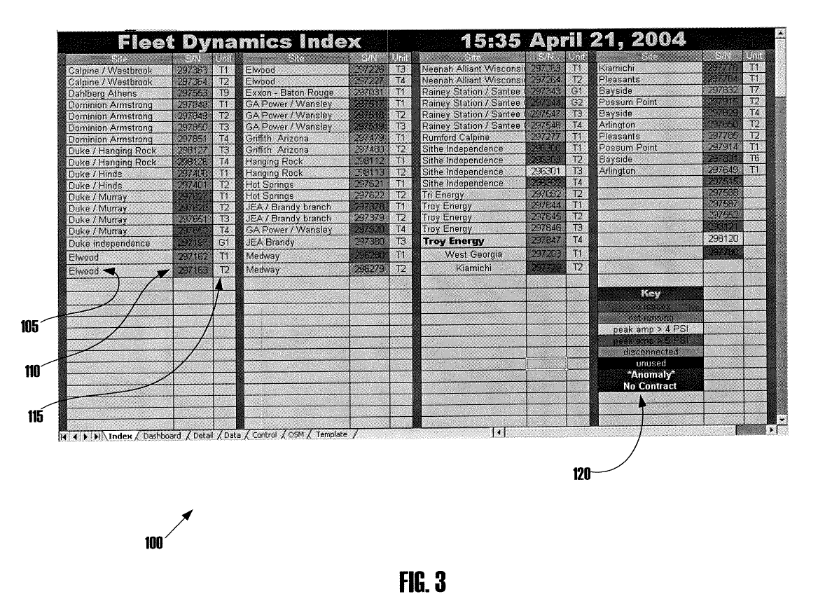

It will be appreciated that the memory 50 in which the fleet data dynamics tool 15 resides may include random access memory, read-only memory, a hard disk drive, a floppy disk drive, a CD Rom drive, or optical disk drive, for storing information on various computer-readable media, such as a hard disk, a removable magnetic disk, or a CD-ROM disk. Generally, the fleet data dynamics tool 15 receives information input or received by the fleet server 12, including dynamics data 85, turbine and other data 80, operator input data 75, and historical data 90. Using this information the fleet data dynamics tool 15 generates the graphical user interfaces described in detail with reference to FIGS. 3, 4 and 6-10 to enable a single user to monitor the combustion dynamics of multiple remote turbines.

Furthermore, given the pressure information provided by a combustion dynamics monitoring devices 23, 27, 32 the operation of each turbine 20, 25, 30 may be altered for superior efficiency and operation. This operation of the turbine 20, 25, 30 may be further refined given turbine data such as the temperature distribution of exhaust gases and fuel flow information for a turbine. It will be appreciated by those of ordinary skill in the art that the turbine data may therefore aid a user of the remote monitoring system of the present invention in interpreting the dynamics monitoring data.

Referring again to FIG. 2, the processor 40 is in communication with the Input/Output (I/O) interface 70 to control I/O devices of the fleet server 12. Typical user I/O devices may include a video display, keyboard, mouse or other input or output devices. Additionally, the I/O interface 70 provides one or more I/O ports and/or one or more network interfaces (e.g., Ethernet connections) that permit the fleet server 12 to receive and transmit information. For instance, according to one aspect of the invention, the fleet server 12 may retrieve data from remote sources, such as via a LAN, WAN, the Internet, or the like, to implement the functions described herein. Therefore, the I/O interface 70 may also include a system, such as a modem, for effecting a connection to a communications network.

The database 65 of the fleet server 12, which is connected to the bus 60 by an appropriate interface, may include random access memory, read-only memory, a hard disk drive, a floppy disk drive, a CD Rom drive, or optical disk drive, for storing information on various computer-readable media, such as a hard disk, a removable magnetic disk, or a CD-ROM disk. In general, the purpose of the database 65 is to provide non-volatile storage to the fleet server 12. As shown in FIG. 2, the database may include one or more tables, segments, files or sub-databases operable to store dynamics data 85, turbine and other data 80, operator input data 75, historical data 90 as well as other information such as computed results from calculations performed by the fleet data dynamics tool 15.

The dynamics data 85 includes the most recent sets of dynamics data received from the combustion dynamics monitoring devices associated with each turbine in a fleet of turbines. The turbine and other data 80, which is optional, includes turbine data received from each monitored turbine. The dynamics data 85 received from the combustion dynamics monitoring devices include, for each frequency band, the maximum, minimum, and median values for pressure as well as frequency and chamber for each. The dynamics data 85 also includes forward mean and standard deviation values for pressure over all combustion chambers for the same multiple frequency bands. Additionally, the dynamics data 85 may include error information for the operating condition of the monitoring device itself.

According to a preferred embodiment of the present invention, all of the dynamics data 85 and any turbine and other data 80 received by the fleet server 12 include turbine identification information that enables the fleet server 12 to correlate the received data 80, 85 with a particular turbine. This identification information is preferably the serial number of the turbine with which the devices are associated. As explained in detail below, the fleet data dynamics tool 15 may use the dynamics data 85 and, optionally, the turbine and other data 80, to generate the graphical user interfaces presented to a user of the fleet data dynamics tool 15. The historical data 90 may also contain historical dynamics, turbine and other data to permit a historical log of such information to be maintained. This may permit a user of the fleet data dynamics tool 15 to consider the operational history of a turbine when making decisions impacting the operation of the turbine. Although the historical data 90 is illustrated as being stored separately from the dynamics data 85 and turbine and other data 80, the historical data 90 may also be stored with the dynamics data 85 and turbine and other data 80.

The operator input data 75 includes information input by a user to control the operation of the fleet data dynamics tool 15. As described in detail below, this information can include the length of time that passes (if any) before the fleet data dynamics tool 15 requests updated dynamics data 85 and turbine and other data 80 from the monitoring devices, default criteria (such as pressure levels) used to generate warnings that turbines may be approaching or exceeding maximum operation levels, and like information. Finally, the database 65 may also include computed results necessary for generating the GUIs discussed in detail below, including color-coded dashboard states, error codes and the like.

It is important to note that the computer-readable media described above with respect to the memory 50 and database 65 could be replaced by any other type of computer-readable media known in the art. Such media include, for example, magnetic cassettes, flash memory cards, digital video disks, and Bernoulli cartridges. It will be also appreciated by one of ordinary skill in the art that one or more of the fleet server 12 components may be located geographically remotely from other fleet server 12 components. For instance, the dynamics data 85 and turbine and other data 80 and historical data 90 may be located geographically remote from the fleet server 12, such that historical data 90 and dynamics data 85 turbine and other data 80 are accessed or retrieved from a remote source in communication with the server 12 via the I/O interface 70.

It should also be appreciated that the components illustrated in FIG. 2 support combinations of means for performing the specified functions described herein. As noted above, it will also be understood that each block of the block diagrams, and combinations of blocks in the block diagrams, can be implemented by special purpose hardware-based computer systems that perform the specified functions or steps, or combinations of special purpose hardware and computer instructions. Further, the fleet server 12 may be embodied as a data processing system or a computer program product on a computer-readable storage medium having computer-readable program code means embodied in the storage medium. Any suitable computer-readable storage medium may be utilized including hard disks, CD-ROMs, DVDs, optical storage devices, or magnetic storage devices. Accordingly, the fleet server 12 may take the form of an entirely hardware embodiment, an entirely software embodiment or an embodiment combining software and hardware aspects, such as firmware.

According to a preferred embodiment, the fleet server 12 represents a stand-alone computer operating a Windows® operating system, where the fleet data dynamics tool 15 represents specialized functions implemented thereby, and the database 65 represents a SQL database. Furthermore, according to a preferred embodiment of the present invention, the fleet data dynamics tool 15 may be implemented by special instructions running on Microsoft Excel™. It will be appreciated that the server 12 may be implemented using alternative operating systems and databases as are known to those of skill in the art. Furthermore, though illustrated individually in FIG. 2, each component of the fleet server 12 may be combined with other components within the fleet server 12 to effect the functions described herein. The functions of the present invention will next be described in detail with reference to block diagram flowcharts and graphical user interfaces describing the processing and graphical display of information by and between the individual elements of FIG. 1, as well as the elements that comprise the embodiment of the fleet server 12 illustrated in FIG. 2.

FIG. 3 shows a graphical user interface generated by the fleet data dynamics tool 15 to enable a user to view the combustion dynamics of a fleet of turbines, according to one embodiment of the invention. Specifically, FIG. 3 shows an index interface 100 that displays a list of all turbines in a fleet of devices, including the site name 105, turbine serial number (S/N) 110, and unit 115. According to one aspect of the present invention, the S/N 110 identifies a specific turbine, such that the site name 105 and unit 115 may be ascertained from the S/N 110. Therefore, given the known S/Ns 110 of turbines within a fleet that is monitored using the systems and methods of present invention, the site names 105 and units 115 may be determined by the fleet data dynamics tool 15 from a lookup table, such as may be stored in the historical data 90 of the database 65.

As shown in FIG. 3, each turbine S/N 110 has a color-coded background to match one of several categories displayed on the key 120 in the index interface 100. The color-coded backgrounds permit a user to quickly determine the operating condition of every turbine in a fleet. Table 1 below illustrates the specific categories, along with a description of each, that correspond to the color-coded S/N 110 background.

TABLE 1
Key Categories

| Color | Category | Description |
|---|---|---|
| Color 1 | No issues | Getting data from device and no unusual values |
| Color 2 | Not running | The peak values for all |
| | | frequency bands are less |
| | | than 1 PSI |
| Color 3 | Peak Amp > | The peak value from at |
| | 4 PSI | least one frequency band is |
| | | over 4 PSI |
| Color 4 | Peak Amp > | The peak value from at |
| | 5 PSI | least one frequency band is |
| | | over 5 PSI |
| Color 5 | Disconnected | Expected data is overdue |
| Color 6 | Unused | No device has been assigned |
| | | to the serial number |
| Color 7 | *Anomaly* | One or more anomalies has |
| | | been detected for this |
| | | unit |
| Color 8 | No Contract | Customer contract has not been signed |

To determine which of the above categories exist for each respective S/N 110, the fleet data dynamics tool 15 compares the most recently received dynamics data 85 and turbine and other data 80, as stored in the database 65, from each turbine to user input data 75, specifically, pre-established combustion dynamics limits used to identify whether a turbine is running properly. As noted throughout the present disclosure, the turbine and other data 80 are optional, though the embodiments of the present invention described herein include the use of such data. The appropriate dynamics data 85 and turbine and other data 80 may be identified by the fleet data dynamics tool 15 by the S/N associated with the data, which is the same as the S/N 110 that identifies the turbines in the index interface 100. As explained in detail below, the index interface uses 1, 4, and 5 PSI as default pre-established limits. Theses limits are stored as user input data 75 within the database 65. Although these default limits are used in the illustrative interface shown in FIG. 3, it will be appreciated that other limits may be established. Furthermore, it will be appreciated that at least some of the categories shown in FIG. 1 are determined without reference to the pre-established combustion limits, such as when no dynamics data is being received from a particular turbine.

With reference to the key 120, when the most-recently received dynamics data falls within the combustion dynamics limits the fleet data dynamics tool 15 provides the S/N 110 with a Color 1 background, which corresponds to “No Issues” category. This means that the turbine is currently operating and within normal parameters. If the most-recently received dynamics data includes pressures in every frequency band that are less than a default pressure of 1 PSI, the Color 2 background is provided, which indicates that the turbine is not running. The Color 3 background is preferably yellow, and is used to illustrate that the peak PSI amplitude from the most-recently received dynamics data, in any frequency band, is greater than 4 PSI. For conventional turbines in a fleet of turbines that are monitored, this may represent a combustion chamber pressure value that is higher than normal, but still within operating limits.

Next, the Color 4 background is preferably red. This illustrated that the most-recently received dynamics data includes at least one measurement of greater than 5 PSI in one of the frequency bands, which may representative of acoustic vibrations that may cause damage to the turbine or the flame in the turbine being extinguished. As such, the Color 4 background is intended to alert the user of the fleet data dynamics tool 15 that a turbine is operating near its fail point. Therefore, a user of the fleet data dynamics tool 15 is alerted of this condition via the index interface. It will be appreciated that the default pressure of 5 PSI may be changed based on the type of turbines within the fleet, as some types of turbines may be able to handle greater combustion chamber pressures.

Color 5 indicates that dynamics data is not being received from the turbine. This may be caused by the connection between the fleet server 12 and turbine being disconnected, as may occur due to a network error or the turbine being off-line. Color 6 indicates that a turbine has not been assigned to the serial number, so no site 105 or unit 115 corresponds to the unused S/N. An anomaly is represented by Color 7, which may occur where the dynamics data is flawed, such as when measurements deviate from normal expectations. The further a measurement deviation is from a pre-set expected value, the more extreme the anomaly classification may become. These classifications typically include yellow (out of normal operating conditions) and red (risk of damage to equipment under these conditions). Finally, Color 8 is indicative of turbines where the customer has not yet signed the service agreement to receive the monitoring function of the fleet dynamics tool.

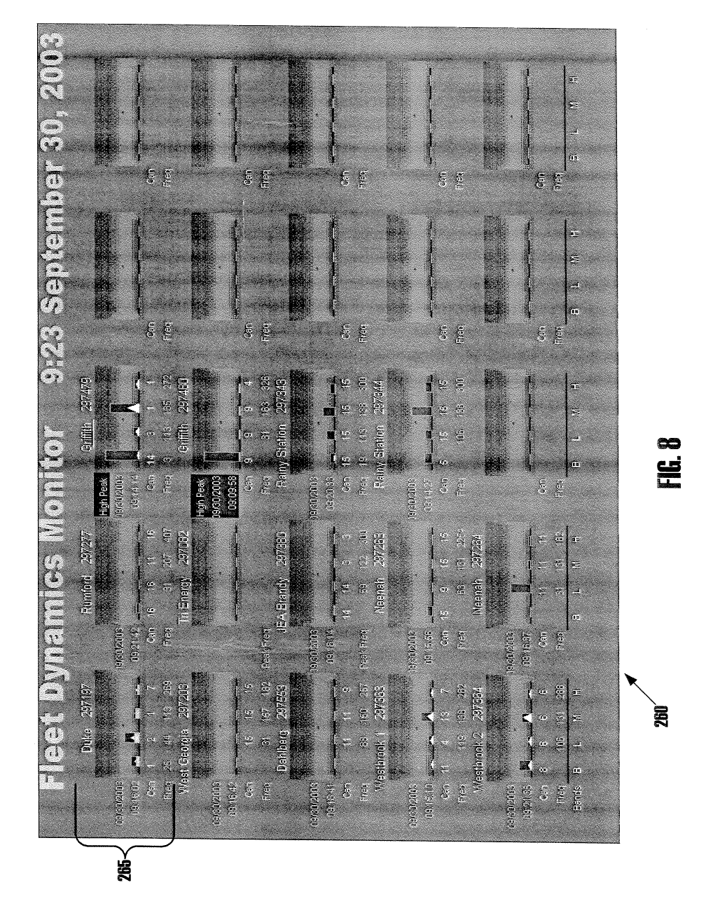

The index interface 100 also permits a user to highlight the site name and unit of a particular turbine by moving an arrow key or cursor (e.g., using a mouse) over the turbine's S/N 110. By left clicking on the S/N 110, or otherwise selecting a S/N 110, a user may open the monitor interface described below with respect to FIG. 8.

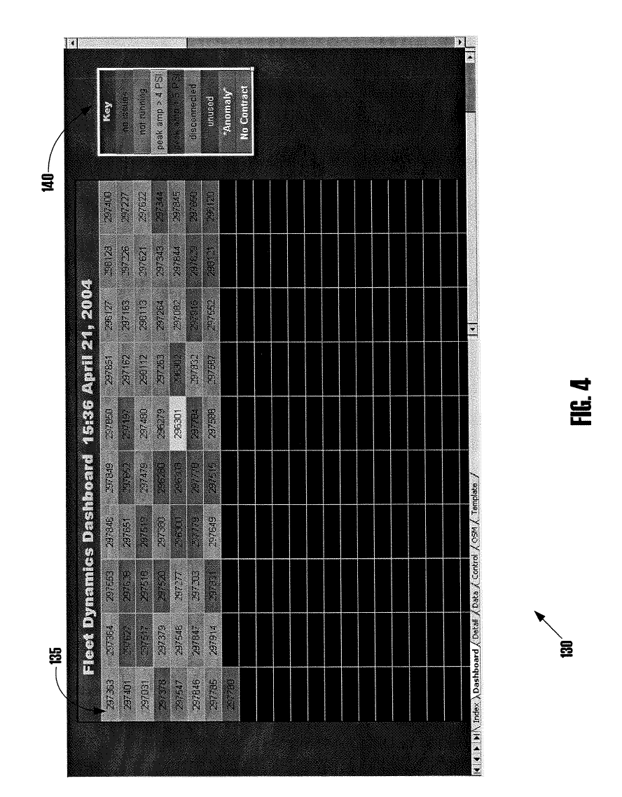

FIG. 4 shows another graphical user interface implemented by the fleet data dynamics tool 15 to enable a user to view the combustion dynamics of a fleet of turbines, according to one embodiment of the invention. The dashboard interface 130 shown in FIG. 4 displays a table of turbine S/Ns 135. These S/Ns 135 correspond to the S/Ns 115 discussed above with respect to FIG. 3. The turbine S/Ns 135 are also color coded using the key 140 categories discussed above with respect to FIG. 3. The dashboard interface provides no additional monitoring information over the index interface 100 of FIG. 3, but permits a larger number of turbines to be simultaneously represented on a single screen. Like the index interface 100, a user may move a mouse cursor over a turbine S/N 135. By left clicking on the S/N 135, or using other input means to select a S/N 135, the user may open the monitor interface described in detail below with respect to FIG. 8. When the monitor interface is opened from the dashboard interface 130 in this manner, the specific S/N 135 selected may be highlighted or outlined in the monitor interface. Furthermore, a pop-up display, such as a Microsoft Excel™tool tip, showing the site name and unit corresponding to a turbine S/N 135 may be displayed when the mouse cursor stops over a turbine S/N 135.

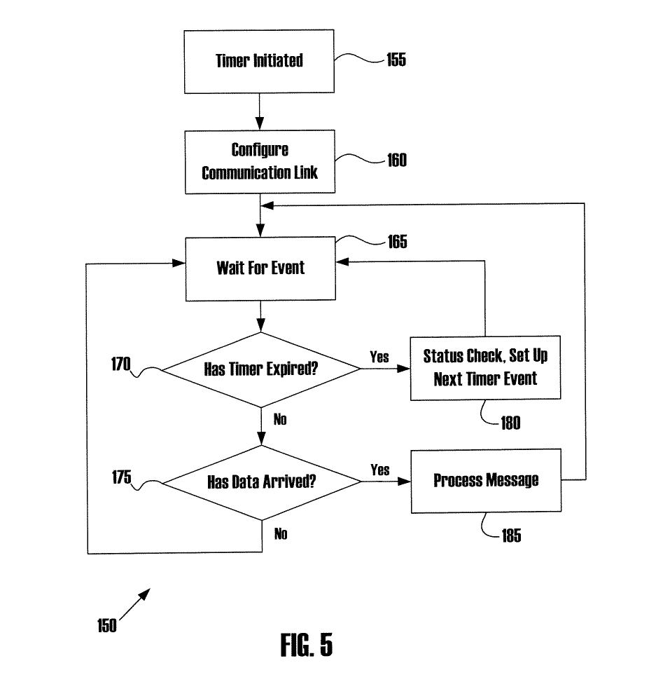

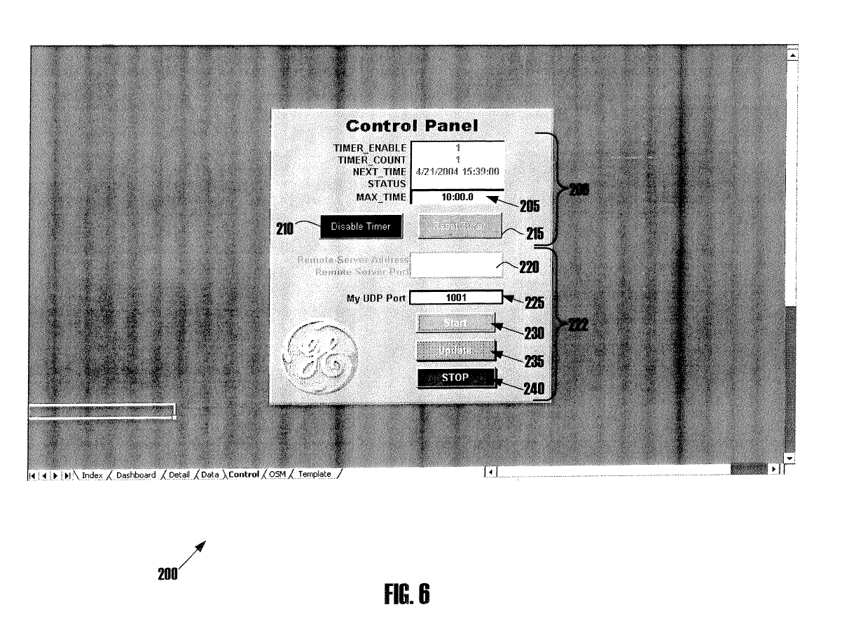

Next, FIG. 5 shows a block diagram flowchart 150 illustrating the timing of transmission of dynamics data in the combustion dynamics monitoring system of FIG. 1, according to one embodiment of the present invention. According to a preferred embodiment of the present invention, the fleet data dynamics tool 15 does not monitor each turbine in real time; rather, the fleet data dynamics tool 15 queries each turbine intermittently, such as every 10 minutes. FIG. 5 illustrates that this process occurs through the use of a timer. In block 155, a timer is initiated, in which a user establishes the amount of time that will pass in between queries of each turbine being monitored by the system of the present invention. This occurs using a control panel, which is discussed in greater below with reference to FIG. 6. The timer data is stored in the user input data 75 of the database 65. The timer begins counting upon initiation by the user. Once a timer is initiated, the fleet server immediately establishes communication with a particular turbine to be queried. More specifically, the fleet server configures a communication link (block 160) through which communication can occur with the combustion dynamics monitoring device and optionally, the turbine monitoring devices, associated with the turbine to be queried.

The fleet data dynamics tool 15 then waits for the timer to expire or for the arrival of the turbine and other data to be received (block 165). If the timer has expired before data arrives (block 170), the fleet server 12 is operable to flag or highlight stale timestamps and dynamics data (block 180). More specifically, if the current time is later than the time of the last received message plus the query time interval, the color of the date and time in the display changes from a green font color on a normal blue background to a yellow font color on a red background. For instance, in FIG. 8 the date and time for Griffith 297480 are shown to be highlighted. The fleet server 12 is also operable to test the connection between the server 12 and the turbine that should have transmitted dynamics data prior to expiration of the timer. The fleet data dynamics tool 15 may then reset the timer (block 180) and wait for the next event. On the other hand, where the dynamics data has arrived, the data is decoded (if necessary) by the fleet data dynamics tool 15 and is stored as dynamics data 85 in the database 65. Based on this newly received data, the fleet data dynamics tool 15 is then operable to update all of the graphical user interfaces described herein.

According to a preferred embodiment of the present invention, six updates per hour per site is sufficient to provide the user information on how a particular turbine site is running. Therefore, the timer is preferably set at 10 minutes. When dynamics data 85 arrives from each site, the data includes a single sample of dynamics data captured at the instant the combustion dynamics monitoring device receives the request for dynamics data from the fleet server 12. According to another aspect of the present invention, the combustion dynamics monitoring devices may average dynamics data readings taken over a period of the last ten minutes, and forward the averaged dynamics data to the fleet server 12. This averaging may drop abnormally high or low values that are in error and may otherwise skew the correct output from the combustion dynamics monitor. Additionally, it will be appreciated that although the present invention is described herein with the operation of a timer, the fleet server 12 may also receive dynamics data from combustion dynamics monitoring devices constantly, on a real-time or near real-time basis.

Next, FIG. 6 shows a control panel interface 200 implemented by the fleet data dynamics tool 15 to enable a user to control the fleet data dynamics tool 15, according to one embodiment of the invention. As described in detail above, combustion dynamics monitoring devices send information packets including dynamics data to the fleet server 12 at a user-configurable rate corresponding to the timer. The fleet data dynamics tool 15 saves these packets in the form of dynamics data 85. The tool 15 accommodates any new packets from new combustion dynamics monitoring devices by overwriting buffers or dynamics data 85 with updated information for existing sources. Alternatively, as discussed above, the fleet data dynamics tool 15 may move or retain old dynamics data and old turbine and other data instead of replacing the data with updated information.

As shown in FIG. 6, the control panel interface 200 is used to control automatic operations of the fleet data dynamics tool 15. The upper frame 206 of the control panel interface 200 includes controls for the timer. The timer is triggered every minute on the minute and updates time and date as well as the color-coding of the status fields in the various worksheets. The MAX_TIME time interval 205 may be set by the user to determine the threshold for stale status warnings, where MAX_TIME is the length of time between each query of the combustion monitors. Buttons are provided to disable 210 and reset 215 the timer. Therefore, the Reset Timer button 215 resets the timer function using the current time and the MAX_TIME query interval to calculate the NEXT_TIME for the timer event.

The lower frame 222 controls communications functions of the fleet data dynamics tool 15. The lower frame 222 includes a remote server address and port field 220, where the remote server address is the IP address of the Fleet Server 12, and the remote server port is the UDP port number for the Fleet Server 12. These are used to enable a user to access the fleet data dynamics tool 15 when using a computer other than the fleet server 12. According to one aspect of the invention, the default remote server address is the IP address for a terminal server, which is a computer that allows multiple users to simultaneously log into the fleet data dynamics tool 15 from their own desktop or laptop computer, where each user has a unique workspace that preserves their own work and preferences. The “my UDP” port field 225 is the UDP port number selected by each user to identify them to the fleet server 12. This may be used to identify particular users, for instance, users with different access rights to particular functions of the fleet data dynamics tool 15. If a port already in use is selected, a message appears on the screen warning the user.

The start button 230 sends a fleet data request to the fleet server 12 with a command requesting that it be put on a subscriber list to receive all subsequent fleet data messages. In response, it gets a dump of all current fleet messages and any new messages that come in the future. The update button 235 sends a fleet data request to the fleet server 12 with a command requesting all current information. In response, it gets a dump of all current fleet messages and any new messages that come in the future. The stop button 240 sends a fleet data request to the fleet server 12 with a command requesting that it be removed from the subscriber list. In response, no further messages will be sent to that client and that client will be removed from the client subscriber list.

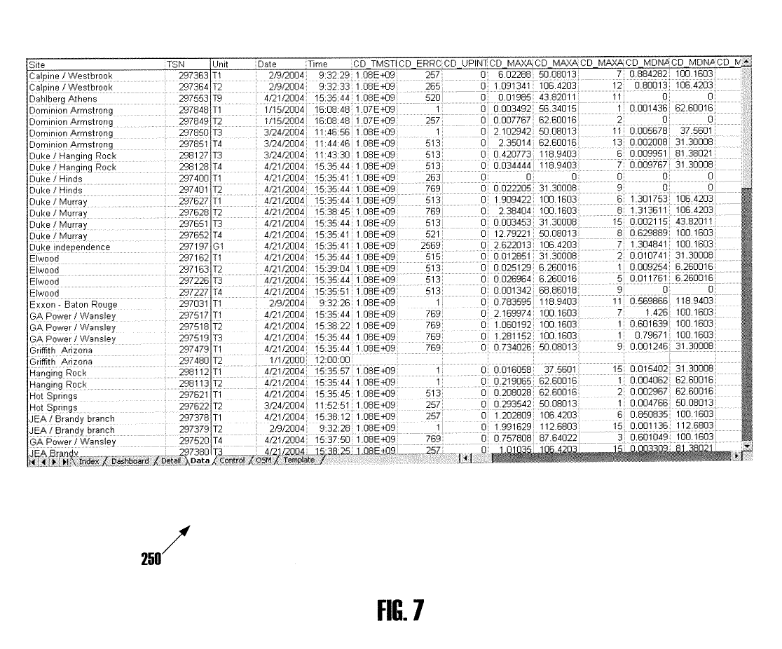

FIG. 7 shows a detail view of dynamics data and turbine and other data received by the fleet server 12 from a fleet turbines, according to one embodiment of the invention. The dynamics data 85 and turbine and other data is provided to a user via the data worksheet interface 250 illustrated in FIG. 7. The interface displays all data transmitted from the combustion dynamics monitors in the fleet.

FIG. 8 shows a monitor interface 260 implemented by the fleet data dynamics tool 15 to enable a user to view graphical representations of the combustion dynamics of a fleet of turbines, according to one embodiment of the invention. Using the monitor interface 260 the user may see, at a glance, the status of an entire fleet. The fleet summary data are organized in a matrix, illustrated in FIG. 8 as five (5) columns wide, and with as many rows as are required (including 5 in FIG. 8). Each cell 265 in the matrix includes the site name, the turbine S/N, the time and date of the most recent data communication, a high peak warning, a chart showing the minimum, maximum and median values for four (4) frequency bands, and the can number and frequency of the maximum value for the respective can.

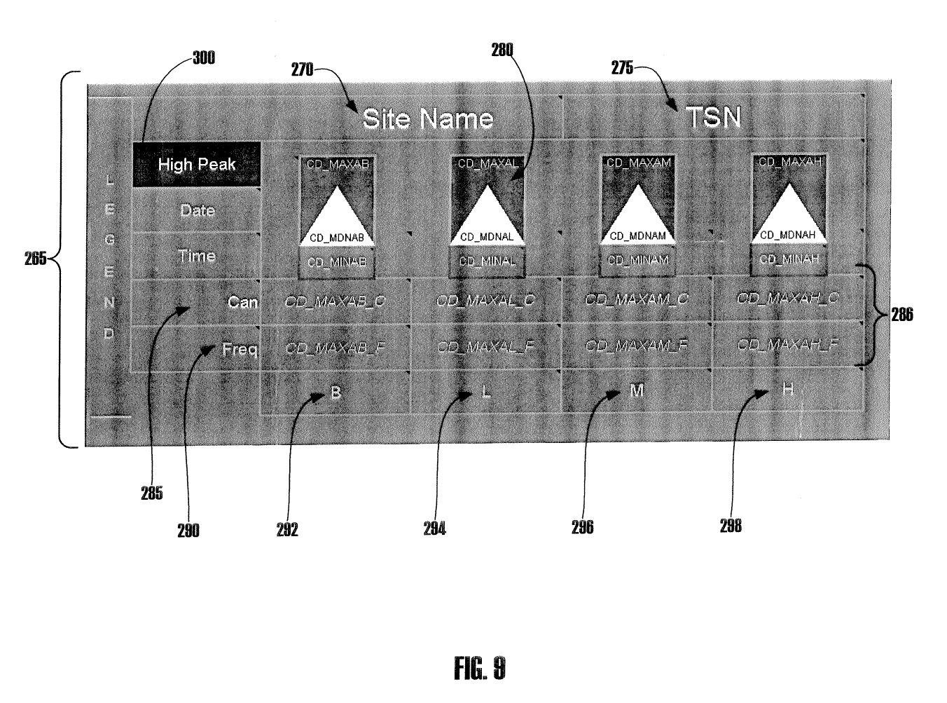

FIG. 9 illustrates how the graphical representation of the combustion dynamics of a turbine is generated in the graphical user interface of FIG. 8, according to one embodiment of the invention. More specifically, FIG. 9 shows how a single cell 265 is generated for use in the monitor interface of FIG. 8. As shown in FIG. 9, the cell components include a site name 270, which displays the name of the site at which the monitored turbine is located. This information is stored in the database 65, for instance, as user input data 75, and may be entered manually for all new turbines to be monitored. The turbine serial number (TSN) 275 displays the S/N for the monitored turbine. Next, the high peak warning 300 is only displayed if the max PSI amplitude for any frequency band exceeds 4 PSI. The background for this warning indicator may be red or blinking so as to warn a user of the high pressure occurring in the turbine.

The date and time fields indicate the date and time of the last report. The grid 286 includes identifies the combustion chamber (or “can”) 285 in which the maximum pressure value reading occurs for each frequency band, illustrated in FIG. 9 as blow out 292 (B), low 294 (L), mid 296 (M), and high 298 (H). Although these frequency ranges are configurable, according to one embodiment of the invention, the blow out 292 (B) band is 0-120 Hertz, the low 294 (L) band is 120-180 Hertz, and the high 298 (H) band is 180-3200 Hertz. Acoustic vibrations in each of the frequency bands help identify typical problems the turbine may be having. For instance, a sluggish fuel valve may cause a low frequency oscillation, whereas dirty fuel injectors may cause an oscillation in a middle frequency. Grid 286 also identifies the frequency of the highest oscillation 290 for each of the bands. For instance, CD_MAXA_BC shows the combustion chamber showing the highest acoustics vibration and CD_MAXA_BF shows the frequency at which the vibration occurred.

The magnitude bar chart 280 shows the magnitude of the frequency vibration for each band. Specifically, the bar chart 280 shows the minimum, median and maximum acoustic vibration values (measured in PSI) for each frequency band. As shown in the figure, each of the minimum, median and maximum values may be represented by different shapes or colors to enable the user to distinguish between the values. For instance, the median value may be represented by a triangle, whereas the maximum value may be shown in red. In the illustrative example shown in FIG. 9, the Duke 297197 turbine has its most significant vibration in can 2, at 44 Hz.

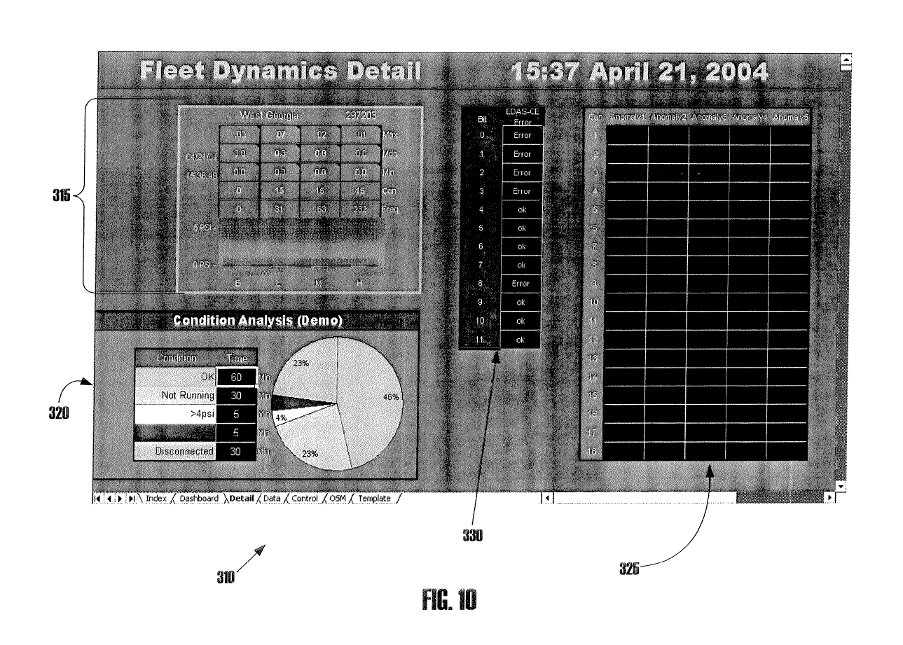

FIG. 10 illustrates a graphical user interface implemented by the fleet data dynamics tool to enable a user to view specific combustion dynamic details of a particular turbine, according to one embodiment of the invention. The detail interface 310 shown in FIG. 10 displays the detailed information for a specific turbine. It reproduces the cell 315 from the monitor interface on the left, although all values are exposed. Point names for these values are available as comments that are displayed whenever the mouse pointer passes over them. EDAS-CE error codes are decoded and displayed in the center of the worksheet. These are errors reported by the EDAS_CE system and include error codes associated with failure of hardware, software, connections, data errors, and the like. Explanations are provided as comments, which are displayed whenever the mouse pointer passes over them. The anomalies are displayed in a table on the right of the sheet. These anomalies are preferably generic and modular, and each may be loaded in a plug and play fashion. The anomaly message may contain a timestamp, the anomaly identifier, and a mask specifying the anomaly state (green, yellow, red) for each combustion chamber.

Many modifications and other embodiments of the inventions set forth herein will come to mind to one skilled in the art to which these inventions pertain having the benefit of the teachings presented in the foregoing descriptions and the associated drawings. Thus, it will be appreciated by those of ordinary skill in the art that the present invention may be embodied in many forms and should not be limited to the embodiments described above. For instance, the present invention may be used to evaluate wind turbines, electric transformers, generators, and hydro-powered equipment. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A system for monitoring a plurality of turbines, comprising:
at least one turbine;
at least one combustion dynamics monitoring device, in communication with the at least one turbine, wherein the at least one combustion dynamics monitoring device is operable to measure the pressure within at least one combustion chamber of the at least one turbine; and
at least one fleet server, wherein the at least one fleet server is in remote communication with the at least one combustion dynamics monitoring device, and wherein the at least one fleet server is operable to generate a graphical display illustrating the operational status of the at least one turbine.

2. The system of claim 1, further comprising at least one turbine monitoring device, in communication with the at least one turbine, wherein the at least one turbine monitoring device is operable to monitor non-pressure related information associated with the at least one turbine.

3. The system of claim 2, wherein the at least one fleet server is in communication with the at least one turbine monitoring device, and wherein the at least one fleet server receives the non-pressure related information from the at least one turbine monitoring device.

4. The system of claim 1, wherein the graphical display generated by the at least one fleet server illustrates the pressure within the at least one combustion chamber of the at least one turbine.

5. The system of claim 4, wherein the graphical display generated by the at least one fleet server simultaneously illustrates the pressure within the at least one combustion chamber of a plurality of turbines.

6. The system of claim 1, wherein the at least one combustion dynamics monitoring device is further operable to generate frequency information revealing acoustic vibrations in the at least one turbine.

7. The system of claim 6, wherein the frequency information comprises the maximum pressure within each of the at least one combustion chamber of the at least one turbine.

8. The system of claim 6, wherein the frequency information reveals acoustic vibrations in the at least one turbine in a plurality of frequency bands.

9. The system of claim 8, wherein the plurality of frequency bands exist within the frequency ranges of 0 to about 3200 Hertz.

10. The system of claim 1, wherein the graphical display generated by the fleet server identifies the combustion chamber having a maximum pressure value measured by the at least one combustion dynamics monitoring device.

11. The system of claim 1, wherein the graphical display generated by the fleet server further comprises the site location of the at least one turbine.

12. The system of claim 1, wherein the at least one fleet server is accessible by users via the Internet.

13. A method for monitoring a plurality of turbines, comprising:
using at least one combustion monitoring device to monitor the pressure within at least one combustion chamber of at least one turbine;
communicating the monitored pressure to at least one fleet server in communication with the at least one combustion monitoring device; and
displaying, using the fleet server, the operational status of the at least one turbine.

14. The method of claim 13, further comprising the step of using at least one turbine monitoring device to monitor non-pressure related information associated with the at least one turbine.

15. The method of claim 14, further comprising the step of receiving, at the at least one fleet server, the non-pressure related information.

16. The method of claim 13, wherein the step of displaying comprises displaying the pressure within the at least one combustion chamber of the at least one turbine.

17. The method of claim 13, wherein the step of displaying comprises simultaneously displaying the pressure within the at least one combustion chamber of a plurality of turbines.

18. The method of claim 13, further comprising the step, performed by the combustion dynamics monitoring device, of generating frequency information revealing acoustic vibrations in the at least one turbine.

19. The method of claim 18, wherein the step of generating frequency information comprises identifying the maximum pressure within each of the at least one combustion chamber of the at least one turbine.

20. The method of claim 18, wherein the step of generating frequency information comprises identifying acoustic vibrations in the at least one turbine in a plurality of frequency bands.

21. The method of claim 20, wherein the plurality of frequency bands exist within the frequency ranges of 0 to about 3200 Hertz.

22. The method of claim 13, wherein the step of displaying comprises displaying the combustion chamber having a maximum pressure value measured by the at least one combustion dynamics monitoring device.

23. The method of claim 13, wherein the step of displaying comprises displaying the site location of the at least one turbine.
